(19) United States
(12) Patent Application Publication
(10) Pub. No.: US 2010/0064521 A1
(43) Pub. Date: Mar. 18, 2010

(54) RAZOR WITH CLEANING BRUSH

(76) Inventor: Douglas DeLong, Cedar Rapids, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/556,988

(22) Filed: Sep. 10, 2009

Related U.S. Application Data
(60) Provisional application No. 61/095,780, filed on Sep. 10, 2008.

(51) Int. Cl. B26B 21/40; B26B 21/52

(52) U.S. Cl. 30/41; 30/535

(57) ABSTRACT

A combination razor and razor brush is disclosed. The brush for cleaning the razor during and after use of the razor is releasably retained inside a hollow handle of the razor so that the brush is always readily accessible.

This application claims priority to U.S. patent application Ser. No. 61/095,780, filed Sep. 10, 2008.

### BACKGROUND OF THE INVENTION

The invention relates generally to razors and, more specifically, to a razor having an integrated brush for cleaning of the razor during and after use.

Razors are in wide use for personal grooming. The majority of such razors have a handle to one end of which is attached a head member which holds one or more razor blades. Often, the head member is releasably attached to the handle so that replacement heads with fresh razor blades can be substituted when the existing blades become dull. A problem that exists with these razors is that hair, skin cells, soap or shaving cream used in the shaving process, and other materials that may be present on the skin, become trapped on the razor blades or in the head member resulting in reduced effectiveness of the razor and perhaps shortening the useful life of the razor or head member.

One solution to removing the hair and other materials from the head member and razor blades is to displace the hair and other materials by passing a brush over the head member and razor blades. Known brushes are separate articles from the razor and therefore must be purchased separately from the razor, are stored separately so that the brush may not always be accessible when the razor is used, and may become permanently separated, for example if the brush is misplaced or forgotten.

### SUMMARY OF THE INVENTION

The present invention consists of a combination razor and brush personal care product wherein the brush is retained when not in use inside the handle of the razor component. The brush component consists of a handle on one end of which is mounted a brush head. The handle of the razor component is hollow and the brush component is sized to slide longitudinally inside the handle of the razor component where it is releasably retained until withdrawn by a user to clean the razor component after use with the brush component. In a preferred embodiment, the brush component is releasably secured to a base member that has screw threads for engagement corresponding screw threads on the end of the handle of the razor component opposite the end with the razor head member so that the brush component can be extracted from the razor component by unscrewing of the base member.

Another aspect of the invention is to provide a replacement product packaging that includes new razor head member and/or blades combined together with a new brush component so that a user can easily and conveniently maintain the razor and brush combination product of the present invention.

### BRIEF DESCRIPTION OF THE DRAWINGS

FIG. 1 is an elevational view of an embodiment of the razor and brush combination of the present invention.

FIG. 2 is a cross-sectional view taken along line 2-2 of FIG. 1.

FIG. 3 is an enlarged, detail cross-sectional view showing the structure of a preferred embodiment for releasably attaching the brush component to a base member.

FIG. 4 is a plan view of a package of replacement blades and brush component of the present invention.

### DETAILED DESCRIPTION OF PREFERRED EMBODIMENTS

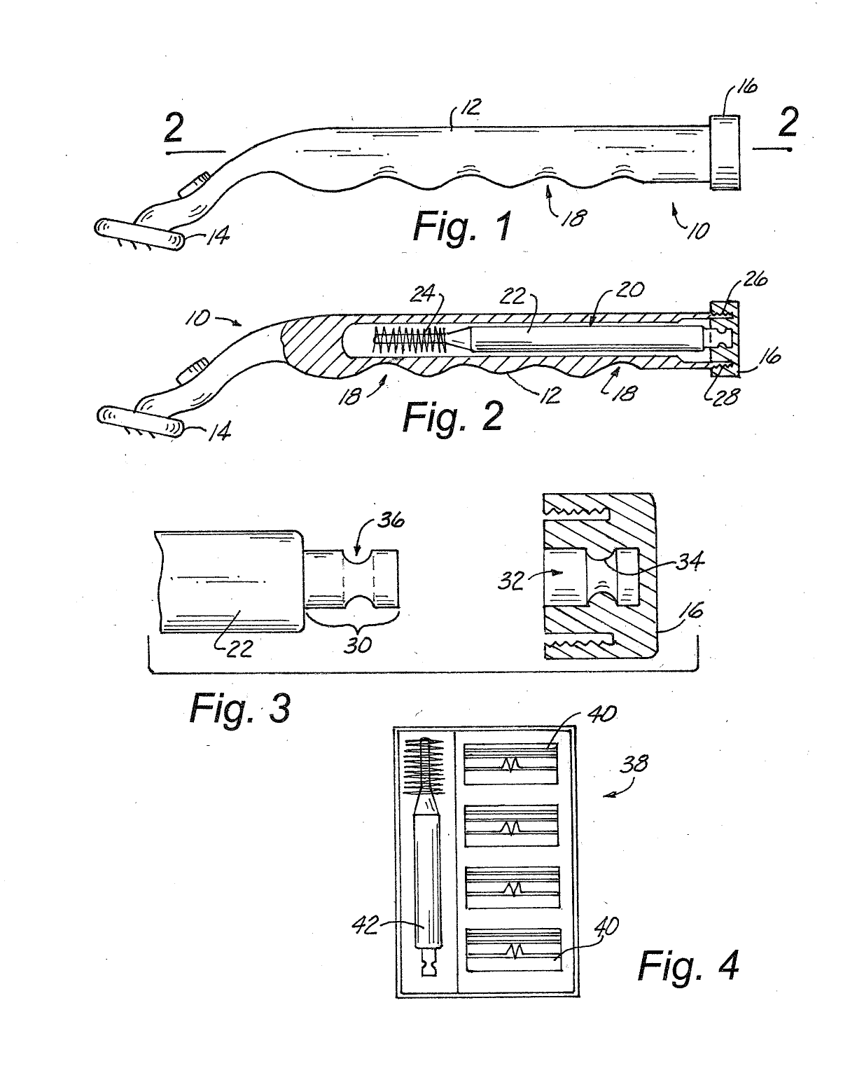

Illustrated in FIG. 1, generally at 10, is a razor and brush combination product of a preferred embodiment of the present invention. The combination product 10 includes a handle 12, a razor head member 14 attached to a first end of the handle 12, and a base member 16 releasably attached to a second end of the handle 12. Preferably, the exterior of the handle 12 has a plurality of recesses 18 to provide for comfortable and secure grasping of the combination product 10 by a user.

A brush component 20 is releasably retained inside the handle 12 (FIG. 2). The brush component 20 includes a brush handle 22 and a brush head 24 mounted on a first end of the brush handle 22. The base member 16 is removable attached to the handle 16 by a cooperating set of screw threads 26 and 28 on the interior or the base member and the exterior of the handle 16, respectively. The brush component 20 is releasably secured to the base member 16. In a preferred embodiment, the main, central section of the brush handle 22 has a round profile for comfortable grasping by a user. The second end of the brush handle 22 includes a reduced profile, generally at 30 (FIG. 3). A corresponding recess 32 is formed in the base member 16 so that the second end 30 of the brush handle 22 can be inserted and retracted from the base member 16. In a preferred embodiment, a detent ridge 34 is formed in the recess 32 and a corresponding detent depression 36 is formed in the second end 30 of the brush handle 22. The detent ridge 34 and detent depression 36 cooperate to allow a user to push the brush handle 22 into the base member 16, forcing the detent ridge 34 into the detent depression 36 whereupon the brush handle 22 is releasably attached to the base member 16, but can be readily detached by a user by forcefully separating the brush handle 22 from the base member 16. In a preferred embodiment, the second end 20 may have a non-circular profile so that it does not rotate inside the base member 16.

In use, a user will shave with the combination product 10 and then use the brush component 20 to clean the razor component. Access to the brush component 20 is made by unscrewing the base member 16 from the handle 12 and then retracting the brush component 20 from inside the handle 12 by withdrawing it longitudinally. Once the cleaning process in complete, the brush component is returned inside the razor handle 12 by inserting it longitudinally and then screwing the base member 16 onto the handle 12. It is preferred that the bush head 24 be received inside the handle 12 in a close fit so as to limit movement and rattling of the brush component 20 inside the handle 12. Obviously, the fit should not be so close that the brush component 20 is difficult to insert or withdraw and also should not be so close that the force required to withdraw the brush component is greater that the force required to retract the brush handle 22 from the base member 16.

The brush head 24, as well as the razor head member 14, will wear with use and need to be replaced. A convenient package for maintaining the combination product 10 is illustrated generally at 38 in FIG. 4. It includes in a single package replacement razor head member 40 and a replacement brush component 42.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A razor combined with a brush for cleaning the razor, comprising:
(a) a razor component comprising a hollow handle and a razor blade attached to a first end of the razor handle; and
(b) a brush component adapted to fit inside the hollow razor handle and comprising a handle and a brush head attached to a first end of the brush handle.

2. A razor combined with a brush for cleaning the razor as defined in claim 1, further comprising a base member releasably secured to the brush component and releasably secured to the razor component to retain the brush component inside the razor component.

3. A razor combined with a brush for cleaning the razor as defined in claim 2, wherein a detent ridge is formed in the base member and a detent recess is formed in the brush handle.

4. A razor combined with a brush for cleaning the razor as defined in claim 2, wherein a detent ridge is formed in the brush handle base member and a detent recess is formed in the base member.
